(19) United States
(12) Patent Application Publication
(10) Pub. No.: US 2026/0159008 A1
(43) Pub. Date: Jun. 11, 2026

(54) CLEAT-BASED ATTACHMENT MOUNTING SYSTEM

(71) Applicant: BDE INVENTIONS, LLC, DYERSVILLE, IA (US)

(72) Inventors: WESLEY CONWAY POOLE, DYERSVILLE, IA (US); DEVON CLARK REGISTER, WELLINGTON, MO (US); IAN LEHN, BONITA SPRINGS, FL (US)

(21) Appl. No.: 19/182,246

(22) Filed: Apr. 17, 2025

Related U.S. Application Data
(60) Provisional application No. 63/636,625, filed on Apr. 19, 2024.

(51) Int. Cl. B60R 11/00; B62D 33/02

(52) U.S. Cl. CPC B60R 11/00; B62D 33/02; B60R 2011/004; B60R 2011/0071; B60R 2011/0078

(57) ABSTRACT

An apparatus and system for mounting attachments to a vehicle includes a planar mounting panel including multiple cleat slots configured to receive a cleat coupled to an attachment, the cleat comprising a foot and a spacer and a plurality of fixing holes configured to receive a fixing mechanism coupled to the attachment to fix the attachment in place on the planar mounting panel.

### RELATED APPLICATIONS

This application claims priority from and the benefit of U.S. Provisional Patent Application Ser. No. 63/636,625 filed on Apr. 19, 2024, the entire contents of which are incorporated herein by reference in their entirety.

### TECHNICAL FIELD

Aspects and implementations of the present disclosure relate to a modular and adaptive mounting system for attachments such as cargo, storage, tools, or any other utility application.

### BACKGROUND

Truck bed storage systems are designed to maximize the utility and organization of a truck's cargo area. They typically include features like drawers, compartments, and racks to securely store tools, equipment, and other items. These systems can be customized to fit different truck models and specific needs, offering solutions for both professional and recreational use. They help keep the truck bed tidy and make accessing items easier and more efficient.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1A depicts a front view of an example of a mounting panel including cleat slots and fixing holes for fixing an attachment to the mounting panel, according to embodiments of the present disclosure.

FIG. 1B depicts a perspective view an example of a mounting panel including cleat slots and fixing holes for fixing an attachment to the mounting panel, according to embodiments of the present disclosure.

FIG. 2 depicts an interconnecting mounting panel system according to embodiments of the present disclosure.

FIG. 3 depicts an example of a cleat slot for fixing an attachment to a mounting panel, according to embodiments of the present disclosure.

FIG. 4A illustrates a side view of an example attachment for a cleat-based attachment system including cleats for fixing the attachment to the cleat-based attachment system, according to embodiments of the present disclosure.

FIG. 4B illustrates a bottom view of an attachment having cleats for fixing the attachment to the cleat-based mounting system, according to embodiments of the present disclosure.

FIG. 5A illustrates a side view of another example of an attachment having cleats for fixing the attachment to the cleat-based mounting system, according to embodiments of the present disclosure.

FIG. 5B illustrates a perspective view of another example of an attachment having cleats for fixing the attachment to the cleat-based mounting system, according to embodiments of the present disclosure.

FIG. 5C illustrates a bottom view of another example of an attachment having cleats for fixing the attachment to the cleat-based mounting system, according to embodiments of the present disclosure.

FIG. 6A depicts a top view of a cleat for mounting an attachment to a cleat-based mounting system, according to embodiments of the present disclosure.

FIG. 6B depicts a side view of a cleat for mounting an attachment to a cleat-based mounting system, according to embodiments of the present disclosure.

FIG. 7A illustrates a spring-loaded locking mechanism in a retracted position, according to embodiments of the present disclosure.

FIG. 7B illustrates a spring-loaded locking mechanism in an engaged position, according to embodiments of the present disclosure.

FIG. 8 illustrates a locking screw for fixing an attachment in place on a cleat-based attachment mounting system, according to embodiments of the present disclosure.

FIG. 9A illustrates an insertion position of an attachment for a cleat-based mounting system, according to embodiments of the present disclosure.

FIG. 9B illustrates an attachment in a locked and fixed position on a cleat-based mounting system, according to embodiments of the present disclosure.

FIG. 10A depicts a perspective view of an example of a cleat-based attachment mounting system deployed to a truck bed, according to embodiments of the present disclosure.

FIG. 10B depicts an overhead view of an example of a cleat-based attachment mounting system deployed to a truck bed, according to embodiments of the present disclosure.

FIG. 10C depicts a rear view of an example of a cleat-based attachment mounting system deployed to a truck bed, according to embodiments of the present disclosure.

FIG. 11 depicts an expanded view of a cleat-based attachment mounting system, according to embodiments of the present disclosure.

FIG. 12A depicts a cross-sectional view of a cleat-based attachment mounting system deployed to a truck bed, according to embodiments of the present disclosure.

FIG. 12B depicts an example mounting structure for mounting the cleat-based attachment mounting system to a truck bed wall, according to embodiments of the present disclosure.

FIG. 13A depicts an example mounting structure for mounting the cleat-based attachment mounting system to a truck bed wall, according to embodiments of the present disclosure.

FIG. 13B depicts another example mounting structure for mounting the cleat-based attachment mounting system to a truck bed wall, according to embodiments of the present disclosure.

FIG. 14A illustrates a lower support structure for a cleat-based attachment mounting system, according to embodiments of the present disclosure.

FIG. 14B depicts a front view of a coupling mechanism for coupling multiple lower support structures together for a cleat-based attachment mounting systems, according to embodiments of the present disclosure.

FIG. 14C depicts a rear view of a coupling mechanism for coupling multiple lower support structures together for a cleat-based attachment mounting systems, according to embodiments of the present disclosure.

FIG. 15 depicts a clamping mechanism for attaching a cleat-based attachment mounting panel to a lip of a truck bed, according to embodiments of the present disclosure.

FIG. 16A illustrates an upper mounting structure for a cleat-based attachment panel, according to embodiments of the present disclosure.

FIG. 16B illustrates an upper mounting structure for mounting a cleat-based attachment panel including elongated holes for vertical adjustment, according to embodiments of the present disclosure.

### DETAILED DESCRIPTION

Organizing, mounting, and fixing items during transport in a vehicle is an issue that many different mounting systems attempt to address. Many different types of systems have been developed for organizing cargo, tools, and so forth, such as toolboxes, drawer systems, cargo bags, wheel well storage, and various bed organizers. Bed organizers may include dividers, racks, bins, tracks, and so forth. Each of these systems, however, include different methods of mounting or attachment to the truck bed, each provides storage or organization for various particular types of items, and each may be deployed to limited positions and locations within a truck bed, van, trailer, etc. Therefore, to build a system that accounts for the various cargo, tools, and so forth that may be necessary for any user requires deploying varying combinations of the different types of truck bed organization systems which can be cost prohibitive, time consuming, unattractive in appearance, and so forth.

Embodiments described herein address the above and other deficiencies of conventional systems by providing a modular and adaptable cleat-based mounting panel system. Some embodiments may include a planar mounting panel including through holes for receiving and fixing attachments having cleats coupled to the attachment. The through holes may be configured with a larger area to receive a foot of a cleat and a narrower portion to receive an space of the cleat. For example, upon inserting the foot of the cleat through the mounting hole, the attachment may be shifted to a position where the space of the cleat sits in the narrower portion of the mounting hole. The foot of the cleat may be a circular disk or any other flat shape which can fit in the larger area of the mounting hole. The space may be of a length extending from the attachment that corresponds to a thickness of the planar mounting panel. In some embodiments, the length of the space may be adjustable to provide the proper length corresponding to the planar mounting panel. Thus, upon being shifted into the fully mounted position, the foot of the cleat may be in contact with the back surface of the mounting panel. Additionally, upon reaching the fully inserted mounting position, a fixing mechanism may fix the cleat, and thus the attachment, in place. For example, a spring-loaded pin or a screw may engage another hole in the mounting panel upon being shifted to the mounting position.

In some embodiments, the attachment may have multiple attached cleats that are spaced according to the spacing of the mounting holes in the mounting panel. Thus, the feet of the cleats can be inserted simultaneously after which the entire attachment can be shifted into the mounted position where the spaces of each cleat are seated in the narrower portion of the mounting hole. In some embodiments, a single fixing mechanism may be used to fix the attachment in place. Alternatively, multiple fixing mechanisms may be used to fix the attachment in place.

In some embodiments, multiple panels may be interconnected to provide a larger surface area for mounting. For example, deployments in a truck bed may include multiple mounting panels interconnected to cover the bed walls and, in some examples, the bed floor. In some examples, the mounting panels may be coupled to a vehicle, such as a truck bed, a trailer, a van, all-terrain vehicle, utility vehicle, etc. Alternatively, the mounting panels may be deployed as a stationary mounting and organization system (e.g., on a shop wall for hanging tools, equipment, organizers, etc.) In some embodiments, the cleats may be integrated with an attachment or may otherwise be fixable to an attachment. An attachment, as referred to herein, may be any item (e.g., equipment, organizer, tool, cargo, etc.) that is couplable with one or more cleats and thus mountable to the mounting panel.

Accordingly, embodiments herein provide for a mounting system that is capable of being universally applied to any type of equipment, cargo, tools, or other item, is adaptable to be deployed in any necessary configuration, and provides a simple attachment mechanism for easy use. Embodiments provide for configuration and reconfiguration of different attachments having a range of applications and used. Thus, embodiments allow users to maximally customize their deployments to fit their needs in a cohesive manner with a singular mounting system. Additionally, the mounting mechanism provides for quick and simple attachment and detachment making configuration and reconfiguration of attachments simple, allowing users to easily adapt their deployments to their needs as their needs change.

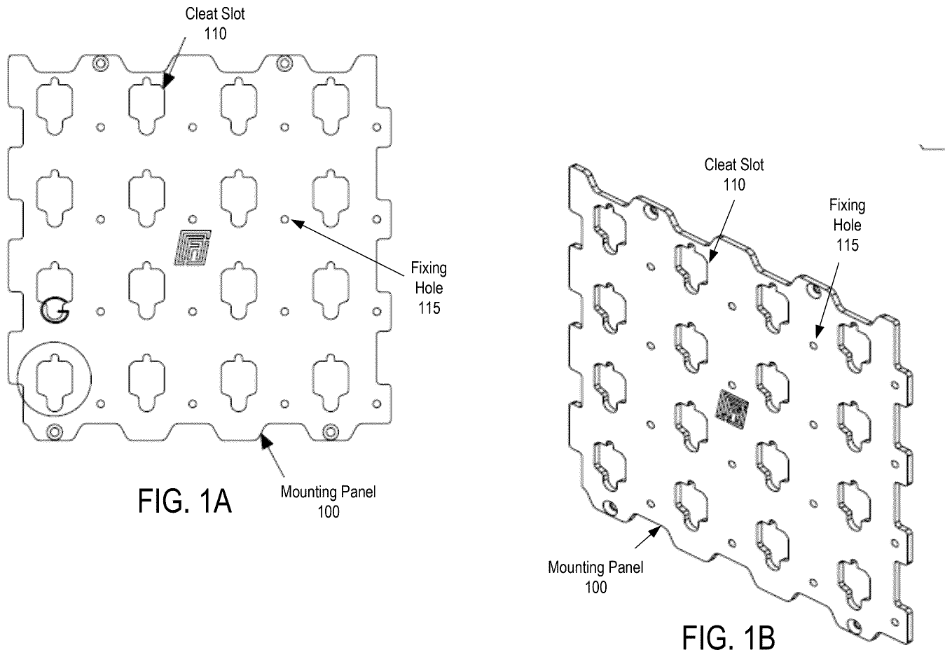

FIGS. 1A and 1B depict a front view and a perspective view of an example mounting panel 100 including cleat slots and fixing holes for fixing an attachment to the mounting panel, according to embodiments of the present disclosure. As can be seen in FIGS. 1A and 1B, the mounting panel 100 may be substantially planar with a thickness that is enough to provide rigidity to the mounting panel 100 in order to support intended or expected loads but that is thin enough to allow a cleat to be inserted and coupled to the panel 100 as described herein. Accordingly, the thickness may depend on the application for which the panel 100 is intended as well as the material the panel 100 consisted of. For example, for heavy duty cargo and tools, the mounting panel 100 may be made of a strong metal, such as steel or the like, and have a relatively larger thickness. Otherwise, if the intended application is small tool organization, the mounting panel 100 may be made of a lighter material, such as a hard plastic or aluminum, or if made of a heavier material, have a smaller thickness.

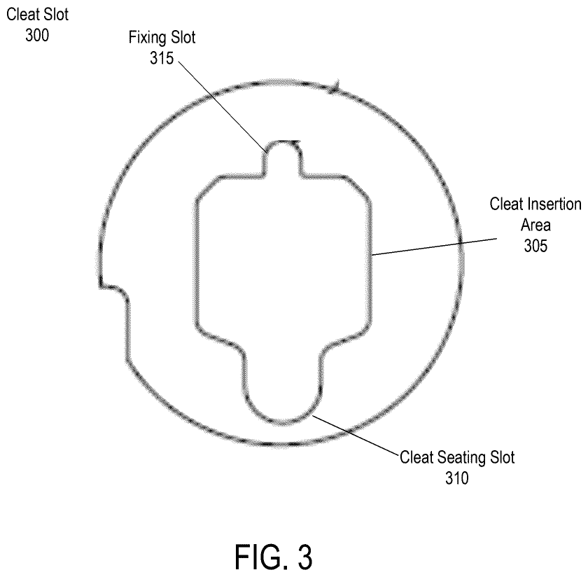

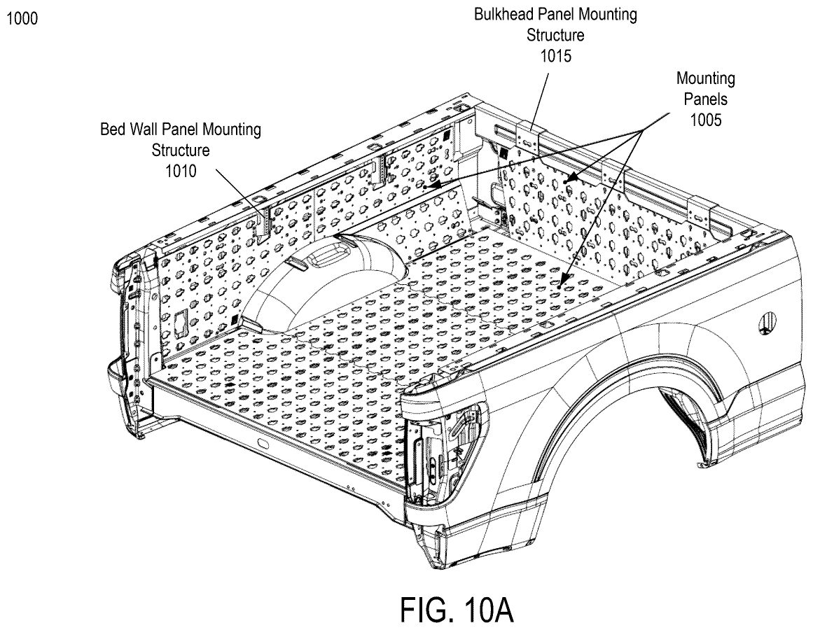

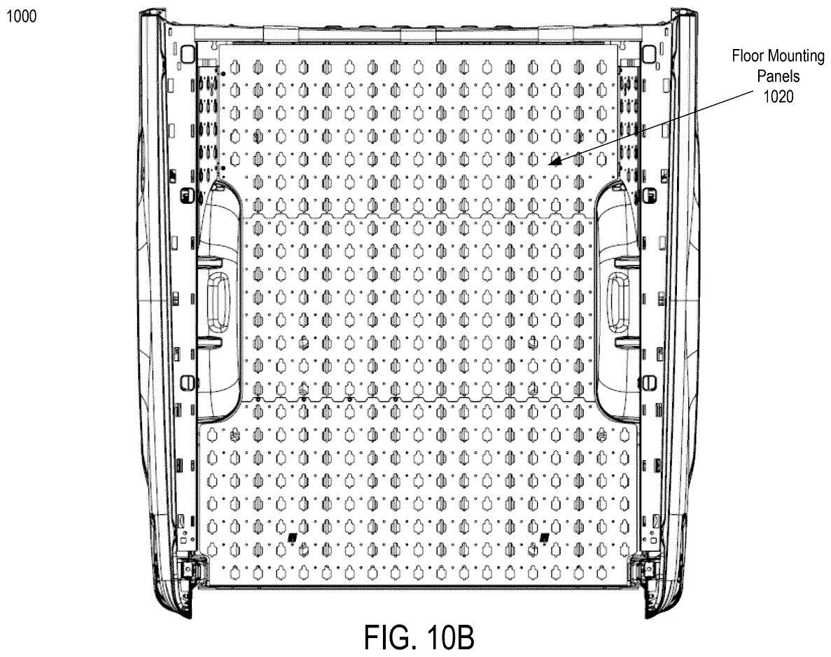

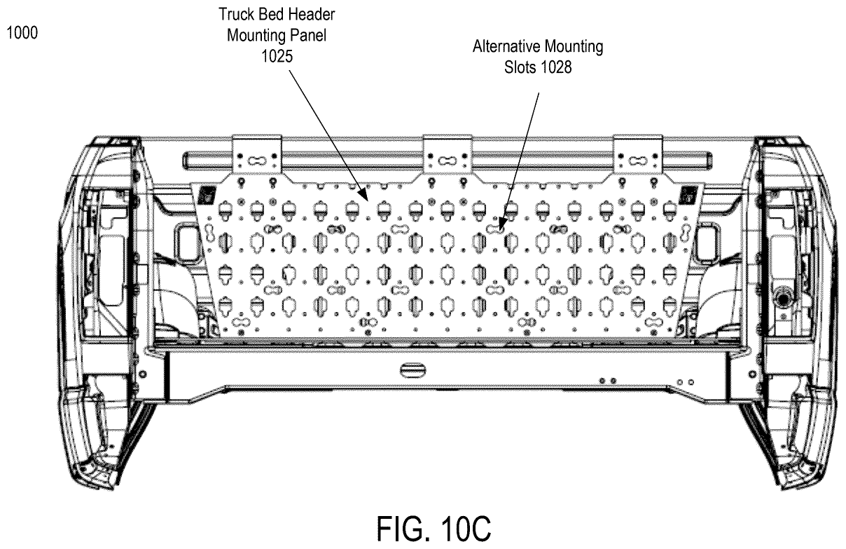

The mounting panel 100 may include a pattern of cleat slots 110 and a corresponding pattern of fixing holes 115. As described in more detail with respect to FIG. 3, each cleat slot 110 may include a larger area for insertion of a foot of a cleat and a smaller slot into which the cleat can be slid into place to be seated within the smaller slot. The fixing holes 115 may be configured to receive a pin or screw, such as a locking pin, set screw, or the like to lock an attachment into place when the cleat of the attachment is seated in the smaller slot. Therefore, when in the seated position and locked in place, the attachment may be firmly mounted to the mounting panel, which may be oriented in any direction (e.g., horizontal, vertical, or anywhere in between). It should be noted that the pattern and configuration of the cleat slots and fixing holes of the mounting panel that are depicted are only one example of possible patterns and configurations. Any alignment and configuration of the cleat slot and fixing holes may be used. Similarly, the shape of the mounting panel may be any shape or form to fit the intended deployment, as can be seen in FIGS. 10-17.

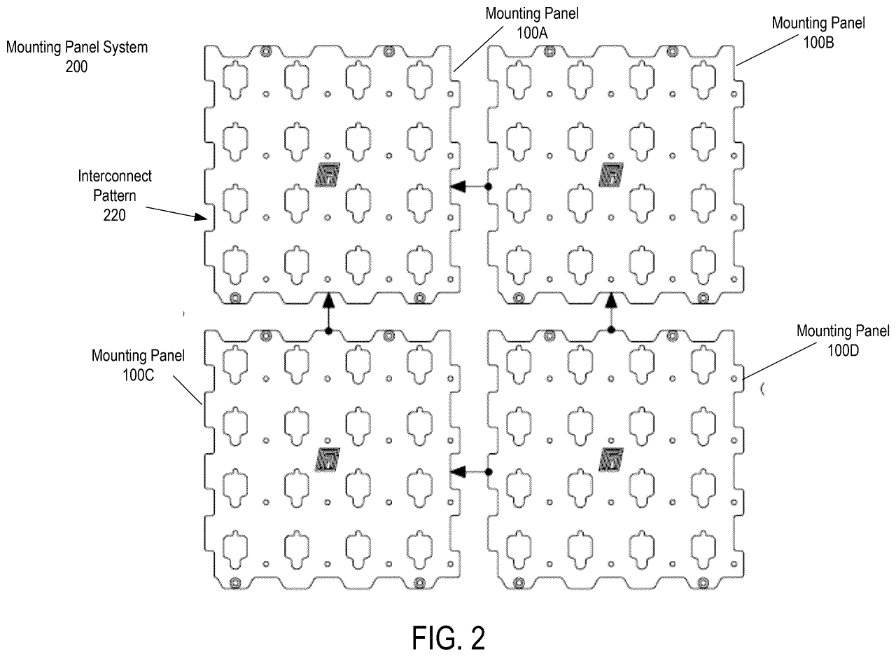

FIG. 2 depicts an interconnecting mounting panel system 200 according to embodiments of the present disclosure. The mounting panel 100 depicted in FIGS. 1A and 1B may be deployed in a system of several mounting panels by interconnected multiple mounting panels 100A-D together. For example, each mounting panel 100A-D may include an interconnect pattern 220 allowing the different mounting panels 100A-D to be coupled closely together and to expand the mounting panel system 200 to any size. In some embodiments, the interconnect patter 220 and the pattern of cleat slots and fixing holes may provide a consistent pattern of cleat slots and fixing holes when multiple mounting panels are coupled together. Accordingly, the configuration of the cleats and locking pin (or other locking mechanism) of an attachment does not have to be changed when mounting across multiple panels. This provides for additional flexibility to mount attachments anywhere on any of the mounting panels 100A-D of the mounting panel system 200. Although only four mounting panels are depicted, it should be noted that any number of mounting panels can be added to the mounting panel system 200 and in any arrangement.

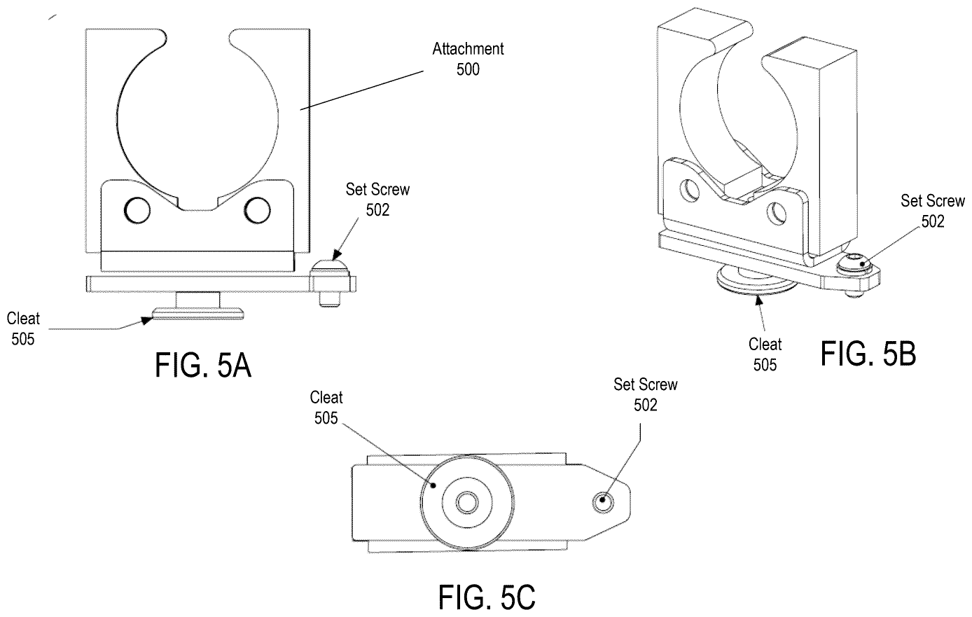

FIG. 3 depicts an example cleat slot 300 for fixing an attachment to a mounting panel, according to embodiments of the present disclosure. The cleat slot 300 includes a cleat insertion area 305, a cleat seating slot 310, and a fixing slot 315. Cleat insertion area 305 may be the widest part of the cleat slot 300 and may configured to receive a foot of a cleat. When inserted, the foot of the cleat may extend completely through the cleat slot. Once fully inserted, the cleat, and the attachment to which the cleat is coupled, may be shifted toward the cleat seating slot 310. The cleat seating slot 310 may be narrower than the cleat insertion area 305 and narrower than the foot of the cleat (e.g., the foot is wider than the seating slot 310). Accordingly, the foot of the cleat, which may be a circular disk or other shape, may slide under the mounting panel while a space of the cleat slides into the cleat seating slot 310. In other words, the foot of the cleat may hold the cleat and the attachment in place on the mounting panel once the cleat and attachment are slid into the cleat seating slot 310. Additionally, once in place in the cleat seating slot 310 a fixing or locking mechanism may engage with a fixing slot. In some embodiments, where the attachment is relatively small (e.g., not large enough to span the cleat slot 300 and a separate fixing hole such as the attachment depicted in FIGS. 5A-C) the locking mechanism may be configured to engage with fixing slot 315. In some embodiments, the fixing slot 315 may be optional and thus the cleat slot 300 may include the cleat insertion area 305 and the cleat seating clot 310 without the fixing slot 315.

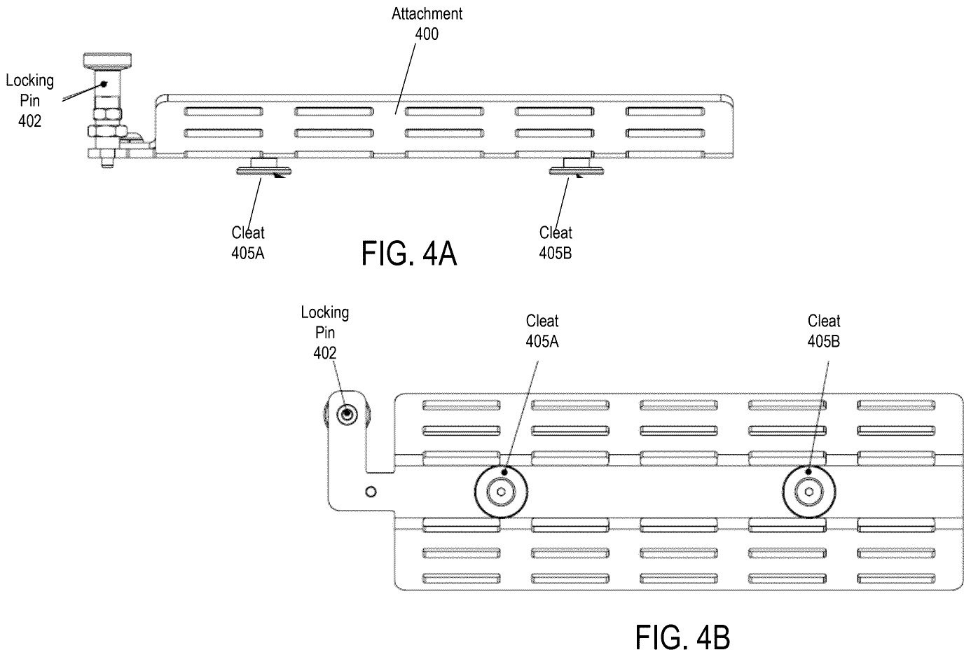

FIGS. 4A and 4B illustrate a side view and a bottom view of an example attachment 400 for a cleat-based mounting system including cleats for fixing the attachment to the cleat-based attachment system, according to embodiments of the present disclosure. In some embodiments, the attachment 400 may include one or more cleats coupled to the attachment 400 and a locking mechanism such as locking pin 402 to fix the attachment 400 in place on a mounting panel when in a fully mounted and seated position on the panel. For example, to mount the attachment 400 to a cleat-based mounting panel, as described herein, the cleats 405A-B may each be inserted into a cleat slot of the mounting panel. Once fully inserted, the entire attachment may be shifted to slide the cleats 405A-B into a seating slot of a corresponding cleat slot for each cleat 405A-B.

Similarly, FIGS. 5A, 5B, and 5C illustrate another example of an attachment 500 having cleats for fixing the attachment to the cleat-based mounting system, according to embodiments of the present disclosure. As depicted, attachment 500 may include a cleat 505 and a locking mechanism such as locking pin set screw 502 to fix the attachment 500 in place on a mounting panel when in a fully mounted and seated position on the panel. For example, the cleat 505 of the attachment may be inserted into a cleat slot of a mounting panel. The attachment 500 may then be shifted into a mounted position in which the cleat 505 is seated within a seating slot of the mounting panel. In the mounted position the foot of the cleat 505 may extend underneath the mounting panel to hold the attachment 500 in place. Furthermore, the set screw 502 may be screwed into place to extend into a fixing hole or fixing slot of the mounting panel, as described above, to lock the attachment 500 in place on the mounting panel.

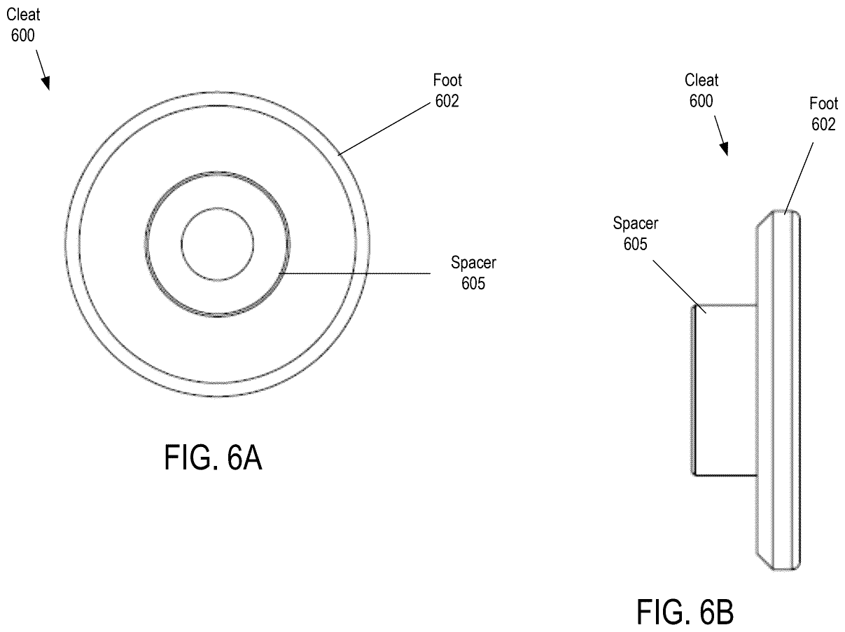

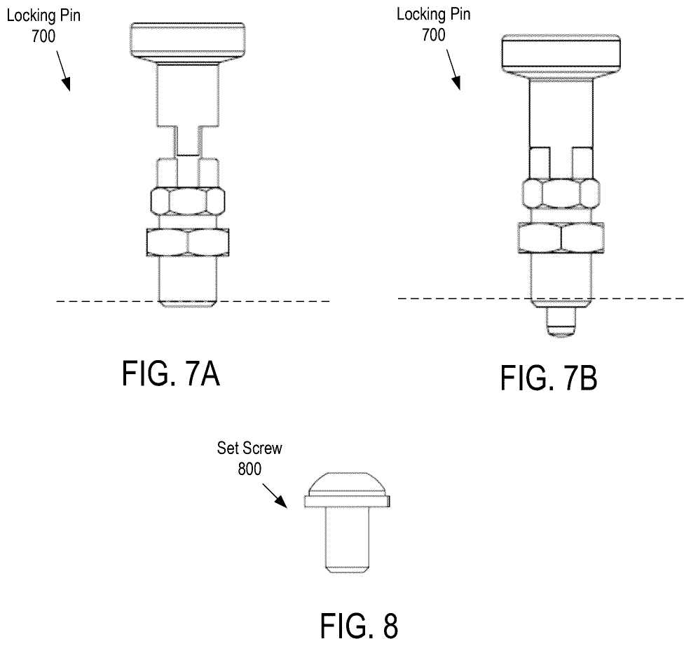

FIGS. 6A and 6B depict a top view and a side view of a cleat 600 for mounting an attachment to a cleat-based mounting system, according to embodiments of the present disclosure. As can be seen in FIGS. 6A and 6B, a cleat 600 includes a foot 602 and a spacer 605. In some embodiments, the entire cleat 600 including the foot 602 and the spacer 605 may be machined from a single piece of material and thus may be inseparable. In other embodiments, the spacer 605 may be separately machines from the foot 602 after which the foot 602 and spacer 605 may be coupled together (e.g., via a screw, bolt, pin, or other fastener) to produce the cleat 600. For example, a bolt may be threaded through the foot 602 and the spacer 605 to attach the cleat 600 to an attachment, as described herein. The foot 602 has a larger diameter that the space 605 to allow the foot 602 to extend through a cleat slot of a mounting panel to the rear side of the mounting panel. In some embodiments, the spacer 605 may have a diameter that corresponds to a seating slot of a cleat slot such that when shifted into the seating slot the spacer 605 has little to no room to move. Therefore, the foot 602 extending underneath to the rear side of the mounting panel may be in contact with the rear side of the panel to hold an attachment in the cleat slot (e.g., the height or depth of the spacer may be the same or similar to the thickness of the mounting panel). Accordingly, when positioned in a mounted position on the mounting panel, the cleat 600 may be held in place orthogonally with respect to the surface of the mounting panel by the foot 602 and in a parallel direction on the surface of the mounting panel by the spacer 605 in the seated slot. A fixing or locking mechanism, such as the locking pin 700 depicted in FIGS. 7A and 7B or a set screw 800 as depicted in FIG. 8, coupled to an attachment and engaging a fixing hole on the mounting panel may further prevent the cleat 600 from sliding out of the seating slot of the cleat slot. In some embodiments, the locking pin 700 may be spring loaded and extend into the fixing hole upon being shifted into the mounted position.

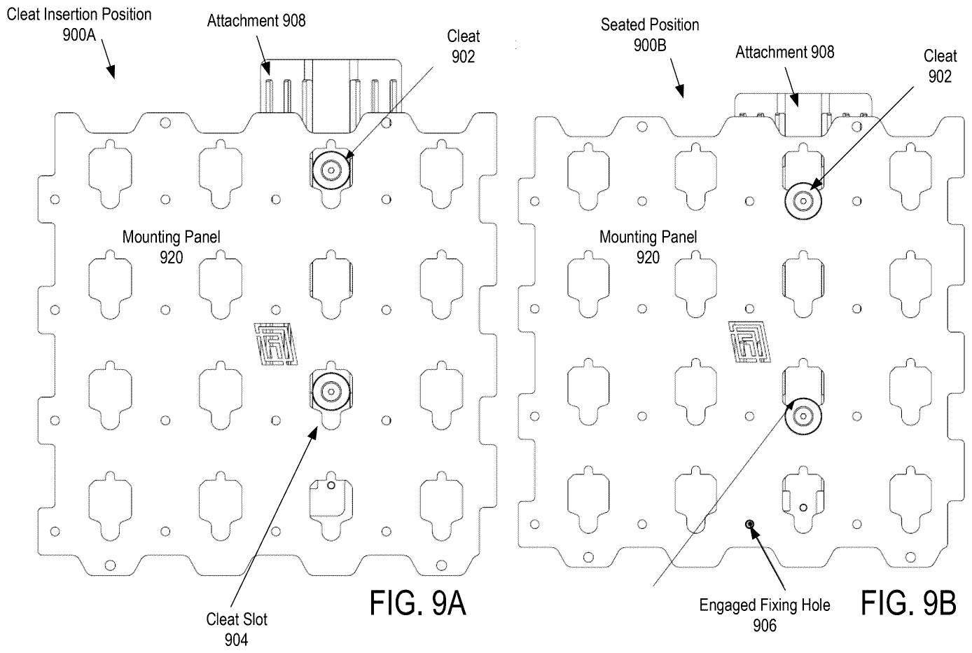

FIG. 9A illustrates an insertion position 900A of an attachment for a cleat-based mounting system, according to embodiments of the present disclosure. As can be seen in FIG. 9A, in the insertion position, each cleat 902 of the attachment 908 is aligned with a larger cleat insertion area of a corresponding cleat slot 904 of a mounting panel 920. Thus, the foot of each cleat 902 can be fed through the larger area of portion of the corresponding cleat slot 904 until the foot of each cleat 902 clears the rear side of the mounting panel 920. FIG. 9B illustrates the attachment 908 in a locked and fixed position 900B on a cleat-based mounting system, according to embodiments of the present disclosure. In the fixed position 900B, the entire attachment 908 is shifted to engage each cleat 902 with a smaller seating slot of the cleat slot 904. Additionally, in the seated position 900B, the foot of each cleat extends behind the mounting panel 920 to hold the attachment 908 on the front surface of the mounting panel 920. Furthermore, a locking or fixing mechanism may engage a fixing hole (e.g., engaged fixing hole 906) to lock the attachment 908 in place on the mounting panel 920 thus preventing the cleats 902 from sliding out of the seating slot. To remove the attachment 908 from the mounting panel 920, the reverse of the above is performed. In other words, the fixing or locking mechanism is disengaged from the fixing hole and the attachment 908 is shifted back to the cleat insertion position 900A where the foot of each cleat 902 can be removed through the larger cleat insertion area of the cleat slots 904.

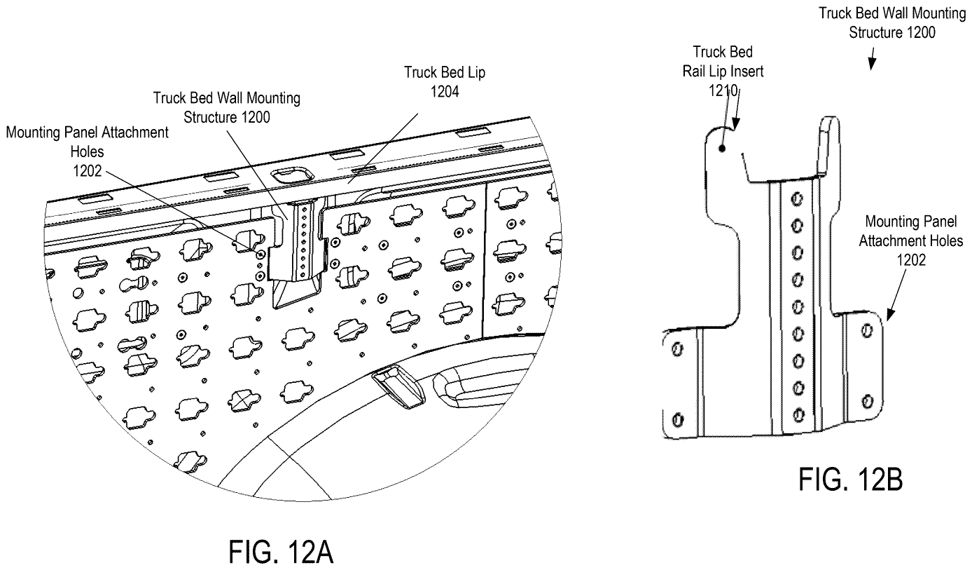

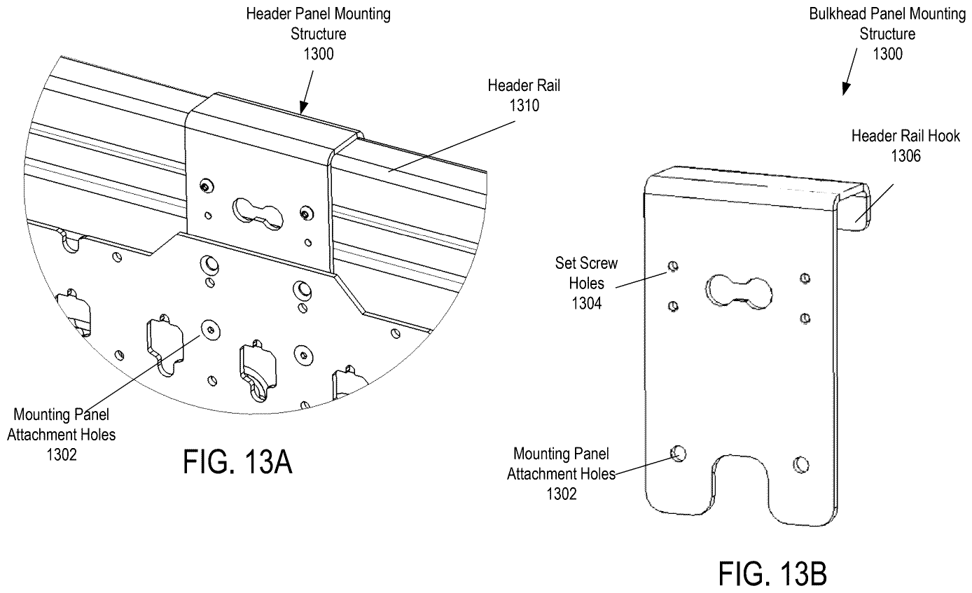

FIGS. 10A, 10B and 10C illustrate a truck bed cleat-based mounting system 1000, accordance with embodiments described herein. FIG. 10A depicts a perspective view of the example truck bed cleat-based mounting system 400 deployed to a truck bed, according to embodiments of the present disclosure. In some embodiments, the truck bed cleat-based mounting system 1000 includes several mounting panels 1005 deployed to the bed walls, the header of the bed, and to the floor of the bed. It should be noted that portions of the truck bed cleat-base mounting system 1000 may be deployed individually and separately, or all together as depicted. For example, in some embodiments, only the header mounting panel may be deployed, one or more of the bed wall panels or one or more of the bed floor panels. Each panel may be mounted to the truck bed via one or more mounting structures. For example, the bed wall panels may be coupled to the bed wall via one or more bolts or fasters as well as one or more specialized bed wall panel mounting structures 1010, described in more detail below with respect to FIGS. 12A and 12B. Similarly, the header panel may be mounted to mounted to the header of the truck bed via a specialized bulkhead panel mounting structure 1015, described in more detail with respect to FIGS. 13A and 13B. FIG. 10B depicts an overhead view of an example of a cleat-based attachment mounting system 1000 deployed to a truck bed, according to embodiments of the present disclosure. In particular, FIG. 10B illustrates a set of bed floor mounting panels 1020. FIG. 4C depicts a rear view of an example of a cleat-based attachment mounting system 1000 deployed to a truck bed, according to embodiments of the present disclosure. In particular, FIG. 10C illustrates a truck bed header mounting panel 1025. In some embodiments, the truck bed header mounting panel 1025, or any other mounting panel as described herein, may include one or more alternative mounting slots 1028 which may be used for attaching tiedowns or other non-uniform connectors. In some embodiments, the alternative mounting slots 1028 may be configured to receive L-track couplers to mount an attachment.

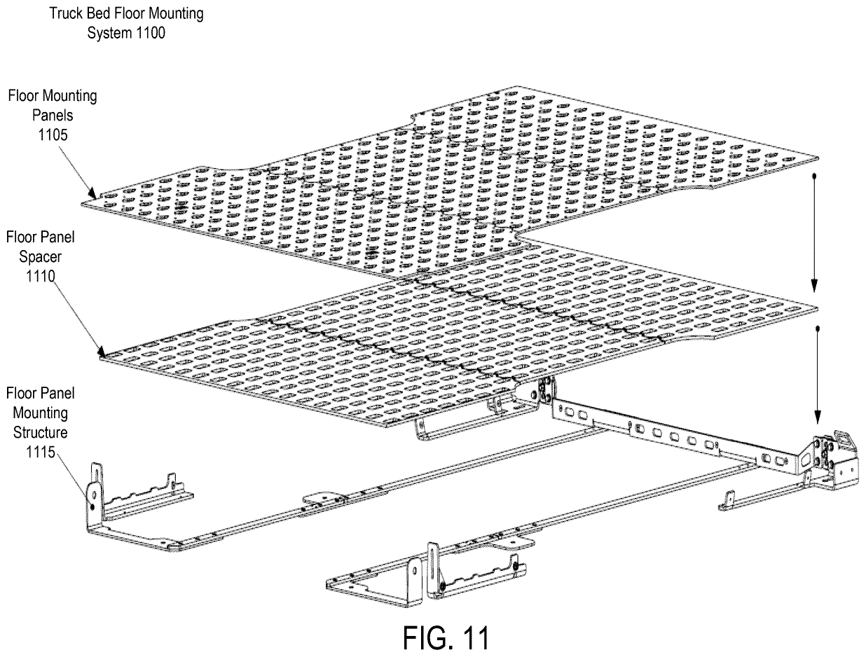

FIG. 11 depicts an expanded view of a truck bed floor mounting system 1100, according to embodiments of the present disclosure. The truck bed floor mounting system 1100 includes one or more floor mounting panels 1105 having cleat slots and fixing holes in configurations as described herein. Additionally, the truck bed floor mounting system 1100 includes a floor panel spacer 1110 and a floor panel mounting structure 1115. The floor panel space 1110 may include a dampening material such as rubber or plastic to provide spacing between the floor mounting panels 1105 and a truck bed floor to allow cleats of attachments to be inserted and coupled to the floor mounting panels 1105. The floor panel spacer 1110 may also provide a dampening affect to reduce vibration transfer from the truck bed to the floor mounting panels 1105 and any attachments coupled to the floor mounting panels 1105. The floor panel spacer 1110 may include holes or slots large enough to allow the foot of a cleat, as described herein, to pass through a cleat slot of the floor mounting panels 1105 to allow mounting of an attachment. The floor panel mounting structure 1115 may be configured to directly attach to existing bolt holes or attachment points in a truck bed. The floor panel spacer 1110 and the floor mounting panels 1105 may then be attached to the floor panel mounting structure 1115. Therefore, the floor mounting panels 1105 can be indirectly coupled to the truck bed using the floor panel mounting structure 1115 without requiring the drilling of additional holes in the truck bed.

FIGS. 12A and 12B depict an example mounting structure 1200 for mounting the cleat-based attachment mounting system to a truck bed wall, according to embodiments of the present disclosure. The truck bed wall mounting structure 1200 may couple to a cleat-based mounting system via one or more mounting panel attachment holes 1202. The mounting structure 1200 may be configured to slide or wedge underneath a lip of a truck bed rail to add additional support to the mounting system without requiring additional drilling of holes in the truck bed rail. As can be seen in FIG. 12B, the truck bed wall mounting structure 1200 may include truck bed rail lip inserts 1210 that are configured to wedge behind a truck bed rail lip 1204 to secure an upper end of the mounting structure to the bed rail.

FIGS. 13A and 13B depict another example mounting structure 1300 for mounting the cleat-based attachment mounting system to a header of a truck bed, according to embodiments of the present disclosure. The header panel mounting structure 1300 may include a set of mounting panel attachment holes 1302 for attaching a mounting panel to the mounting structure 1300. Additionally, the header panel mounting structure 1300 may include a header rail hook 1306 for placing over a header rail 1310. Accordingly, the header panel mounting structure may support the mounting panel by hanging the header rail hook 1306 over the header rail 1310. To keep the header panel mounting structure 1300 in place, a set of set screw holes 1304 may receive one or more set screws that may be engaged after installing the header panel mounting structure 1300 on the header rail. The set screws may be configured to engage a seam on the header rail 1310 or otherwise clamp the header panel mounting structure 1300 to the header of the bed.

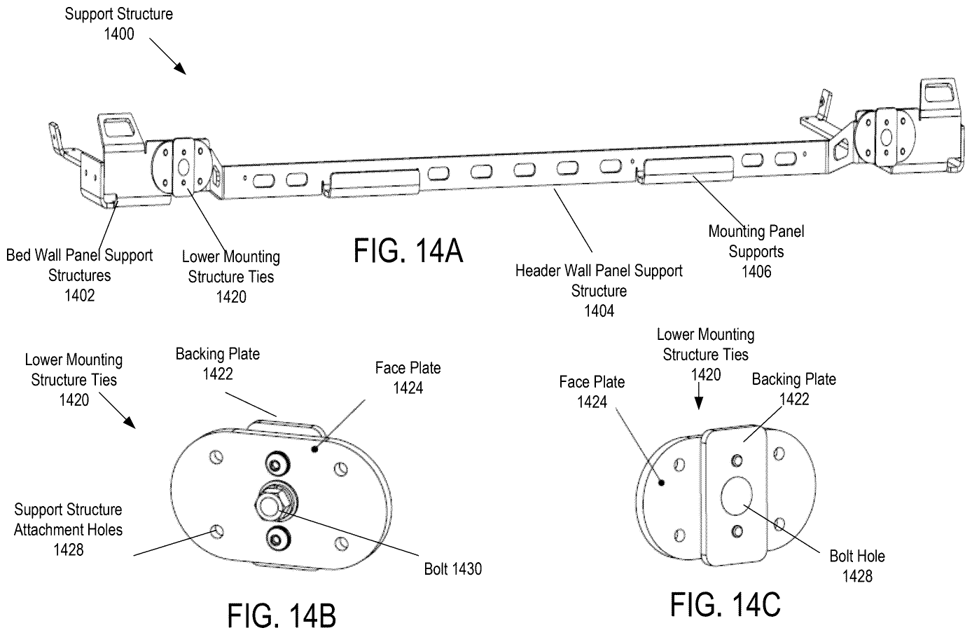

FIGS. 14A, 14B, and 14C illustrate a lower support structure 1400 for a cleat-based mounting system, according to embodiments of the present disclosure. The support structure 1400 may include bed wall panel support structures 1402 and header wall panel support structures 1404 that may be coupled together to view one or more lower mounting structure ties 1420. In some embodiments, one or more of the bed wall panel support structures or the header wall panel support structure 1404 may be attached to a truck bed via existing attachment points (e.g., bolt holes) or via drilled attachment points. In some embodiments, the lower mounting structure ties 1420 may couple the header wall panel support structure 1404 to the bed wall panel support structures 1402. In some embodiments, one or more mounting panels, as described herein, may be attached to or supported by each of the bead wall panel support structures 1402 and the header wall panel support structure 1404. For example, a header mounting panel may sit on and be supported by mounting panel supports 1406.

In some embodiments, the lower mounting structure ties 1420 may include a face plate 1424 that includes one or more support structure attachment holes 1428 for coupling the bed wall panel support structure 1402 to one side of the lower mounting structure tie 1420 and the header wall panel support structure 1404 to another side of the lower mounting structure ties 1420. In some embodiments, the face plate 1424 and the backing plate 1422 are loosely assembled with a bolt 1430 in the middle bolt hole 1428. Accordingly, the backing plate 1422 may initially be rotatable around the bolt 1430 with respect to the face plate 1424. To attach the support structure 1400 to a header wall, the backing plate 1422 may be rotated to be parallel with the face plate 1424. The lower mounting structure ties 1420 may then be attached to the header wall by inserting the backing plate 1422 through a slot in the header wall that is slightly smaller than the face plate 1424. Once inserted, the backing plate 1422 may be rotated to the illustrated perpendicular position, after which the backing plater 1422 may be fixed in place (e.g., via one or more bolts, screws, pins, or the like) on the face plate 1424 to hold the lower mounting structure ties 1420 in place on the header wall via the slot. All fasteners may then be tightened to lock the entire assembly into slot.

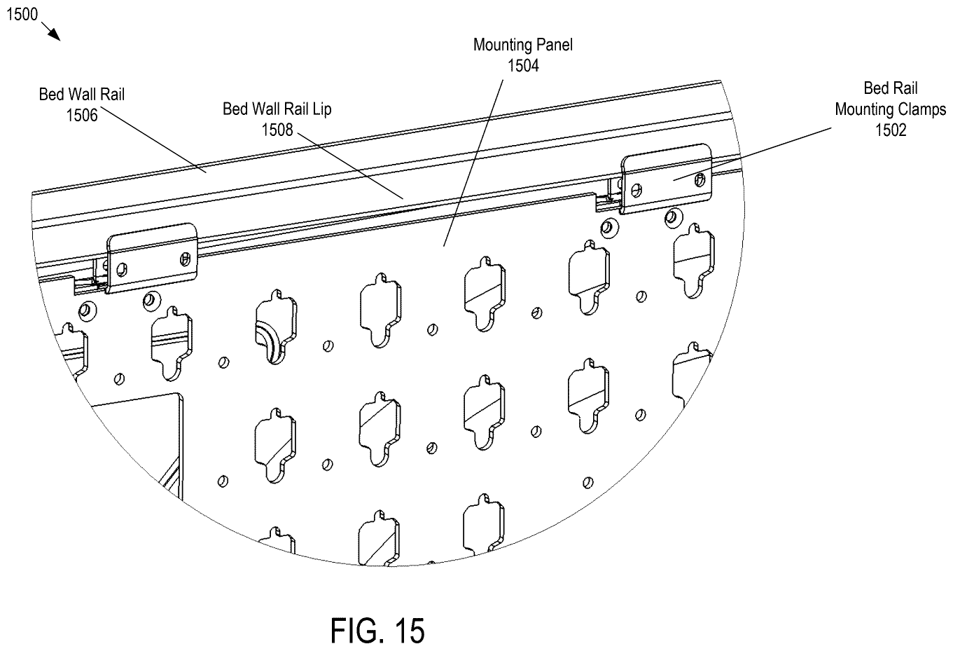

FIG. 15 depicts a clamping-based configuration 1500 for attaching a cleat-based attachment mounting panel to a lip of a truck bed, according to embodiments of the present disclosure. The configuration 1500 includes one or more bed rail mounting clamps 1502 for coupling a mounting panel 1504 to a truck bed wall rail lip 1508. The bed rail mounting clamps 1502 may be coupled to the mounting panel 1504 on one side and clamped around the bed wall rail lip 1508 on the other side. In some embodiments, the bed rail mounting clamps 1502 may be configured with an angle of the upper portion to mirror an angle of the bed wall rail lip 1508 such that, when clamped, the mounting panel 1504 extends parallel to the truck bed wall from the bed wall rail 1506.

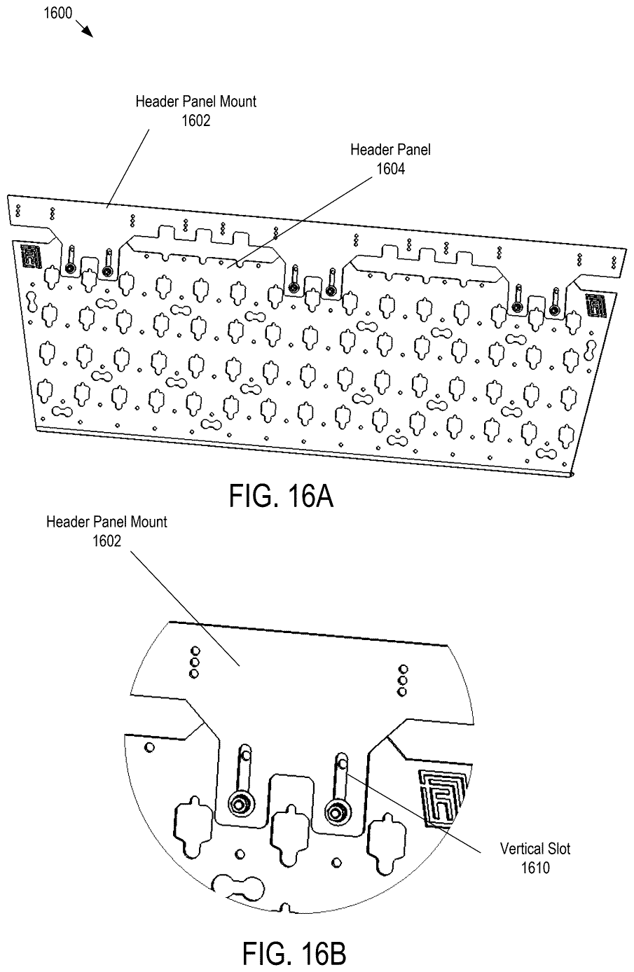

FIGS. 16A and 16B illustrate an upper mounting structure 1600 for a cleat-based attachment panel, according to embodiments of the present disclosure. The mounting structure 1600 may include a header panel mount 1602 which may be mounting to a header wall of a truck bed. Alternatively, header panel mount 1602 may be a general upper mount and may be attached to any portion of a truck bed, trailer, van, wall, etc. The header panel mount 1602 may include one or more vertical slots 1610 for coupling a mounting panel to the header panel mount 1602. The vertical slots 1610 may be elongated to allow for vertical adjustment of the mounting panel 1604, providing additional flexibility and customization for users.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. An apparatus, comprising:
a planar mounting panel comprising:
a plurality of cleat slots configured to receive a cleat coupled to an attachment, the cleat comprising a foot and a spacer; and
a plurality of fixing holes configured to receive a fixing mechanism coupled to the attachment to fix the attachment in place on the planar mounting panel.

2. The apparatus of claim 1, wherein each cleat slot comprises an insertion area to receive the foot of the cleat, and a seating slot to receive the spacer of the cleat upon being shifted into a fixed position.

3. The apparatus of claim 2, wherein the fixing mechanism comprises a spring loaded pin configured to engage a fixing hole upon shifting the attachment into the fixed position.

4. The apparatus of claim 2, wherein the foot of the cleat comprises a circular disk having a diameter that is smaller than insertion area and wider than the seating slot and wherein the spacer has a height that corresponds to a thickness of the planar mounting panel.

5. The apparatus of claim 1, wherein the planar mounting panel further comprises one or more patterned edges configured to be coupled with at least one other planar mounting panel.

6. The apparatus of claim 1, wherein the planar mounting panel is coupled to a vehicle using existing bolt holes of the vehicle.

7. The apparatus of claim 1, wherein the planar mounting panel is coupled to a vehicle using at least one mounting structure, the at least one mounting structure comprising a plurality of elongated holes to allow for vertical adjustment of a height of the planar mounting panel.

8. The apparatus of claim 1, wherein the planar mounting panel is coupled to a vehicle using at least one clamping mechanism.

9. The apparatus of claim 1, wherein the planar mounting panel is coupled to a bed of a pickup truck using at least one mounting structure, wherein the at least one mounting structure couples to a lip of a truck bed wall and extends vertically downward from the lip of the truck bed wall.

10. A mounting system, comprising:
a plurality of planar mounting panels, each mounting panel of the plurality of mounting panels comprising:
a plurality of cleat slots configured to receive a cleat coupled to an attachment, the cleat comprising a foot and a spacer; and
a plurality of fixing holes configured to receive a fixing mechanism coupled to the attachment to fix the attachment in place on the planar mounting panel.

11. The mounting system of claim 10, wherein the cleat slots comprise an insertion area to receive the foot of the cleat, and a seating slot to receive the spacer of the cleat upon being shifted into a fixed position.

12. The mounting system of claim 11, wherein the fixing mechanism comprises a spring loaded pin configured to engage a fixing hole upon shifting the attachment into the fixed position.

13. The mounting system of claim 11, wherein the foot of the cleat comprises a circular disk having a diameter that is smaller than insertion area and wider than the seating slot and wherein the spacer has a height that corresponds to a thickness of the planar mounting panel.

14. The mounting system of claim 10, wherein at least one of the plurality of planar mounting panels further comprises one or more patterned edges configured to be coupled with at least one other planar mounting panel.

15. The mounting system of claim 10, wherein at least one of the plurality of planar mounting panels is coupled to a vehicle using existing bolt holes of the vehicle.

16. The mounting system of claim 10, wherein at least one of the plurality of planar mounting panels is coupled to a vehicle using at least one mounting structure, the at least one mounting structure comprising a plurality of elongated holes to allow for vertical adjustment of a height of the planar mounting panel.

17. The mounting system of claim 10, wherein at least one of the plurality of planar mounting panel is coupled to a vehicle using at least one clamping mechanism.

18. The mounting system of claim 10, wherein at least one of the plurality of planar mounting panel is coupled to a bed of a pickup truck using at least one mounting structure, wherein the mounting structure couples to a lip of a truck bed wall and extends vertically downward from the lip of the truck bed wall.
